(19) United States
(12) Patent Application Publication
(10) Pub. No.: US 2025/0208269 A1
(43) Pub. Date: Jun. 26, 2025

(54) INFORMATION PROCESSING DEVICE, INFORMATION PROCESSING METHOD, AND PROGRAM

(71) Applicant: SONY GROUP CORPORATION, TOKYO (JP)

(72) Inventors: MASATOSHI YOKOKAWA, TOKYO (JP); YUTA SAKURAI, TOKYO (JP)

(21) Appl. No.: 18/846,599

(22) PCT Filed: Mar. 6, 2023
(86) PCT No.: PCT/JP2023/008306

§ 371 Date: Sep. 12, 2024

(30) Foreign Application Priority Data
Mar. 22, 2022 (JP) 2022-045018

(51) Int. Cl. G01S 7/4865; G01S 7/48

(52) U.S. Cl. CPC G01S 7/4865; G01S 7/4808

(57) ABSTRACT

Data to be used for subsequent processing is selected and transmitted while reducing distance measurement data. An information processing device (100) includes a peak detection unit (110), a peak determination unit (120), and an output unit (130). The peak detection unit (110) detects at least one peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency. The peak determination unit (120) determines whether or not the peak includes a peak corresponding to the reflected light. The output unit (130) outputs a peak selected on the basis of a determination result of the peak determination unit and an already output peak previously output as distance measurement data.

### FIELD

The present disclosure relates to an information processing device, an information processing method, and a program.

### BACKGROUND

A distance measurement device based on a time of flight (ToF) method that irradiates an object with light, detects reflected light reflected by the object, and measures a distance to the object by measuring a time of flight of the light is used. In this distance measurement device, a light receiving unit that detects the reflected light generates a histogram in which a detection frequency of the time of flight is a frequency. Data of this histogram is transmitted to a processing unit in a subsequent stage, and the processing unit calculates the distance (see, for example, Patent Literature 1).

### CITATION LIST

### Patent Literature

Patent Literature 1: JP 2021-038941 A

### SUMMARY

### Technical Problem

However, in the above-described conventional technique, since the data of the histogram is transmitted, there is a problem that a transmission data amount increases. In particular, when a distance measurement range is wide, there is a problem that a data amount of the histogram increases and data transmission becomes difficult.

Therefore, the present disclosure proposes an information processing device, an information processing method, and a program that select and transmit data to be used for subsequent processing while reducing distance measurement data.

### Solution to Problem

An information processing device according to the present disclosure includes: a peak detection unit that detects a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency; a peak determination unit that determines whether or not the peak includes a peak corresponding to the reflected light; and an output unit that outputs, as distance measurement data, the peak selected on a basis of a determination result of the peak determination unit and an already output peak previously output.

An information processing method according to the present disclosure includes: detecting a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency; determining whether or not the peak includes a peak corresponding to the reflected light;

selecting the peak on a basis of a result of the determination and an already output peak previously output; and outputting the selected peak as distance measurement data.

A program according to the present disclosure includes: a peak detection procedure of detecting a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency; a determination procedure of determining whether or not the peak includes a peak corresponding to the reflected light; a selection procedure of selecting the peak on a basis of a result of the determination and an already output peak previously output; and an output procedure of outputting the selected peak as distance measurement data.

### BRIEF DESCRIPTION OF DRAWINGS

FIG. 1 is a diagram illustrating a configuration example of a distance measurement device according to embodiments of the present disclosure.

FIG. 2A is a diagram illustrating an example of a time-of-flight data group according to the embodiments of the present disclosure.

FIG. 2B is a diagram explaining time-of-flight data according to the embodiments of the present disclosure.

FIG. 3A is a diagram illustrating an example of a time-of-flight histogram according to the embodiments of the present disclosure.

FIG. 3B is a diagram explaining the time-of-flight data according to the embodiments of the present disclosure.

FIG. 4 is a diagram illustrating a configuration example of an information processing device according to a first embodiment of the present disclosure.

FIG. 5 is a diagram illustrating a configuration example of a peak detection unit according to the embodiments of the present disclosure.

FIG. 6A is a diagram illustrating an example of selection of a peak according to the embodiments of the present disclosure.

FIG. 6B is a diagram illustrating an example of selection of a peak according to the embodiments of the present disclosure.

FIG. 7A is a diagram illustrating an example of selection of a peak according to the embodiments of the present disclosure.

FIG. 7B is a diagram illustrating an example of selection of a peak according to the embodiments of the present disclosure.

FIG. 7C is a diagram illustrating an example of selection of a peak according to the embodiments of the present disclosure.

FIG. 8 is a diagram illustrating an example of a processing procedure of information processing according to the first embodiment of the present disclosure.

FIG. 9 is a diagram illustrating a configuration example of an information processing device according to the first embodiment of the present disclosure.

FIG. 10 is a diagram illustrating an example of an ambient light image according to a second embodiment of the present disclosure.

FIG. 11 is a diagram illustrating an example of a processing procedure of information processing according to the second embodiment of the present disclosure.

FIG. 12 is a diagram illustrating an example of an information processing device according to a third embodiment of the present disclosure.

FIG. 13 is a diagram illustrating an example of a linear region according to the third embodiment of the present disclosure.

FIG. 14 is a diagram illustrating a configuration example of a linear region detection unit according to the third embodiment of the present disclosure.

FIG. 15 is a diagram illustrating an example of a processing procedure of information processing according to the third embodiment of the present disclosure.

### DESCRIPTION OF EMBODIMENTS

Hereinafter, embodiments of the present disclosure will be described in detail with reference to the drawings. The description will be given in the following order. Note that, in each of the following embodiments, the same parts are denoted by the same reference numerals, and redundant description will be omitted.
1. First Embodiment
2. Second Embodiment
3. Third Embodiment

### 1. First Embodiment

### [Configuration of Distance Measurement Device]

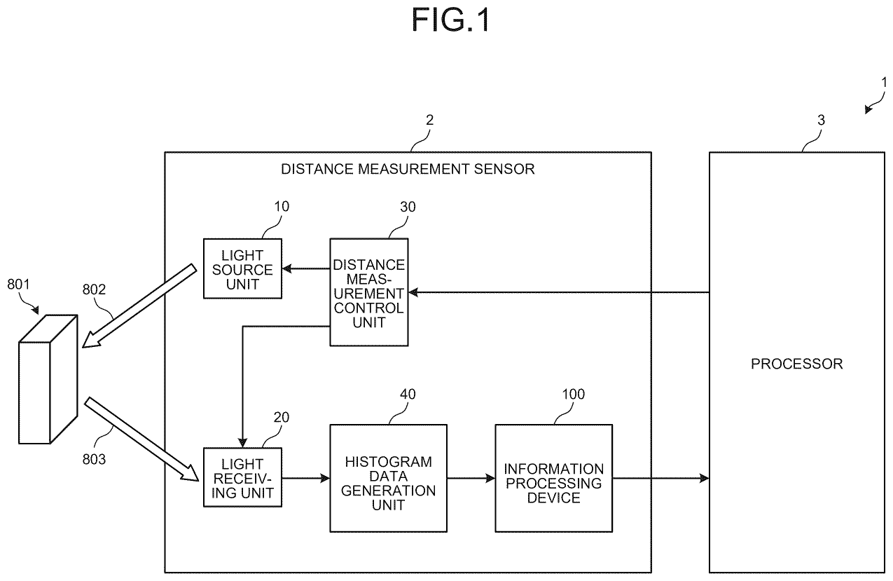

FIG. 1 is a diagram illustrating a configuration example of a distance measurement device according to embodiments of the present disclosure. The drawing is a block diagram illustrating a configuration example of a distance measurement device 1. The distance measurement device 1 is a device that measures a distance to an object. The distance measurement device 1 measures the distance to the object by emitting light to the object, detecting light reflected by the object, and measuring a time of flight which is a time from emission of the light to the object to incidence of the reflected light. The drawing illustrates a case where a distance to an object 801 is measured. In the drawing, the distance measurement device 1 irradiates the object 801 with emitted light 802 and detects reflected light 803.

The distance measurement device 1 includes a distance measurement sensor 2 and a processor 3. The distance measurement sensor 2 measures the above-described time of flight to generate distance data to the object. In addition, the distance measurement sensor 2 outputs the distance data to the processor 3.

The processor 3 controls the distance measurement sensor 2 and detects the distance to the object on the basis of the distance data output from the distance measurement sensor 2. The distance to the object can be calculated from the time of flight and speed of light. The processor 3 can be configured by a central processing unit (CPU) or a digital signal processor (DSP).

The distance measurement sensor 2 includes a light source unit 10, a light receiving unit 20, a distance measurement control unit 30, a histogram data generation unit 40, and an information processing device 100.

The light source unit 10 emits emitted light (emitted light 802) to an object. For example, a laser diode can be used for this light source unit 10.

The light receiving unit 20 detects reflected light (reflected light 803) from an object. This light receiving unit 20 includes a pixel array unit in which a plurality of light receiving pixels each having a light receiving element that detects reflected light is arranged in a two-dimensional matrix shape. For this light receiving element, a single photon avalanche diode (SPAD) can be used. In addition, the light receiving unit 20 generates an image signal on the basis of the detected reflected light and outputs the image signal to the histogram data generation unit 40.

The histogram data generation unit 40 generates a time-of-flight histogram on the basis of the image signal from the light receiving unit 20. This time-of-flight histogram is a histogram representing a distribution of the time of flight of the reflected light emitted from the light source and reflected from the object by a frequency and a class of a detection frequency. The time-of-flight histogram is formed by integrating the detection frequencies of the plurality of reflected lights accompanying the emission of the plurality of emitted lights. The light receiving unit 20 described above includes the light receiving pixels arranged in the two-dimensional matrix, and generates the image signal for each light receiving pixel. The histogram data generation unit 40 generates a histogram for each pixel region in a two-dimensional matrix corresponding to these light receiving pixels. The plurality of time-of-flight histograms for each pixel region in the two-dimensional matrix is referred to as a time-of-flight histogram group. The histogram data generation unit 40 generates the time-of-flight histogram group on the basis of the image signals from the light receiving unit 20, and outputs the time-of-flight histogram group to the information processing device 100.

The distance measurement control unit 30 controls the light source unit 10 and the light receiving unit 20 to perform distance measurement. The distance measurement control unit 30 causes the light source unit 10 to emit laser light and notifies the light receiving unit 20 of emission timing. The light receiving unit 20 measures a time of flight on the basis of this notification.

The information processing device 100 processes the time-of-flight histogram group output from the histogram data generation unit 40. The information processing device 100 performs preprocessing of distance measurement, extracts a region of a class corresponding to the reflected light from the object from the time-of-flight histogram group, and outputs the region to the processor 3.

As the preprocessing described above, the information processing device 100 outputs a peak that is the region of the reflected light from the object in the time-of-flight histogram as distance measurement data. As a result, an amount of information of data to be output to the processor 3 can be reduced. Furthermore, the information processing device 100 selects and outputs data necessary for processing of the processor 3. The processor 3 may perform processing such as noise removal at the time of distance measurement. The information processing device 100 outputs distance measurement data including the data necessary for such processing of the processor 3.

The processor 3 performs distance measurement to calculate a distance to the object on the basis of the data output from the information processing device 100. In addition, the processor 3 further performs signal processing such as noise removal.

[Configuration of time-of-flight data group]

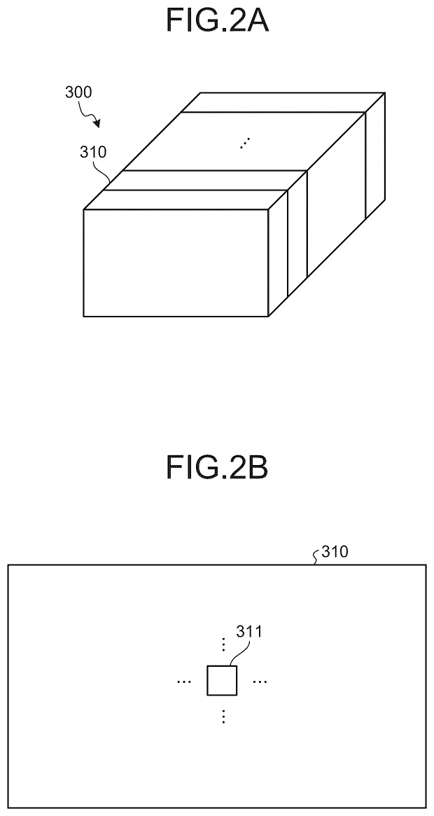

FIG. 2A is a diagram illustrating an example of a time-of-flight data group according to the embodiments of the present disclosure. A time-of-flight data group 300 in the drawing has a plurality of pieces of time-of-flight data 310. The time-of-flight data 310 included in the time-of-flight data group 300 is arranged in time series. In addition, a pixel (pixel region 311) of each time-of-flight data 310 stores a detection frequency of a corresponding class width (bin: bins) of a time-of-flight histogram. The time-of-flight data group 300 is three-dimensional data having a spread in X, Y, and Z directions representing depth.

FIG. 2B is a diagram illustrating the time-of-flight data according to the embodiments of the present disclosure. The time-of-flight data 310 stores data of the plurality of pixel regions. In the pixel region 311 in the drawing, a frequency of a class corresponding to the time-of-flight data 310 of the histogram of the pixel in the light receiving unit 20 corresponding to the pixel is stored. The frequency of the class corresponds to a detection frequency of the time of flight.

### [Configuration of Time-of-Flight Histogram]

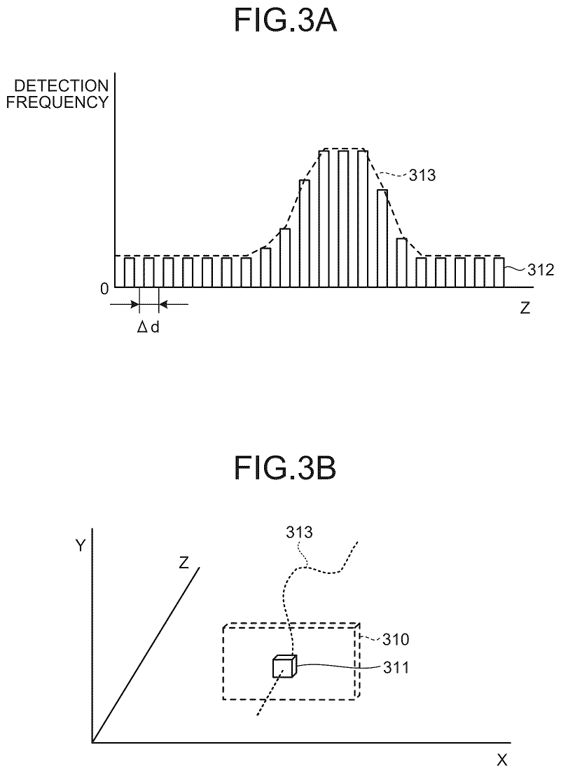

FIG. 3A is a diagram illustrating an example of a time-of-flight histogram according to the embodiments of the present disclosure. The drawing is a diagram illustrating an example of a histogram generated by the light receiving unit 20. The histogram in the drawing is a graph in which a frequency 312 of a detection frequency of a class width Δd is disposed over a detection range of a time of flight. The horizontal axis in the drawing represents the Z direction of the time-of-flight data group 300 illustrated in FIG. 2A. This Z direction corresponds to the time of flight. The drawing further indicates a time-of-flight histogram 313 represented by a curve. In the time-of-flight histogram 313 of the drawing, an upwardly protruding region is a region of a class in which reflected light or the like is detected. This protruding region is referred to as a peak.

FIG. 3B is a diagram illustrating the time-of-flight data according to the embodiments of the present disclosure. This drawing illustrates the time-of-flight data 310 extracted from the time-of-flight data group 300. A detection frequency of one class of the time-of-flight histogram 313 is stored in the pixel region 311 of the time-of-flight data 310. A plurality of such pixel regions is arranged in the X and Y directions. Further, time-of-flight data similar to the time-of-flight data 310 is arranged in time series in a depth direction to constitute the time-of-flight data group 300. For example, in a case where a distance measurement range is 150 m and resolution (class width) is 15 cm, there are 1000 pieces of data in a Z-axis direction. This data is generated for each pixel region. The time-of-flight data group 300 can also be regarded as a set of time-of-flight histograms 313 for each two-dimensional pixel region. This set of time-of-flight histograms 313 is referred to as a time-of-flight histogram group. The histogram data generation unit 40 in FIG. 1 generates a time-of-flight histogram in a time-series frame period and sequentially outputs the time-of-flight histogram.

When the processor 3 processes such a time-of-flight histogram group, a processing load on the processor 3 increases. In addition, a transmission time of the time-of-flight histogram group between the distance measurement sensor 2 and the processor 3 becomes long. Therefore, the preprocessing is performed by the information processing device 100 described above.

### [Configuration of Information Processing Device]

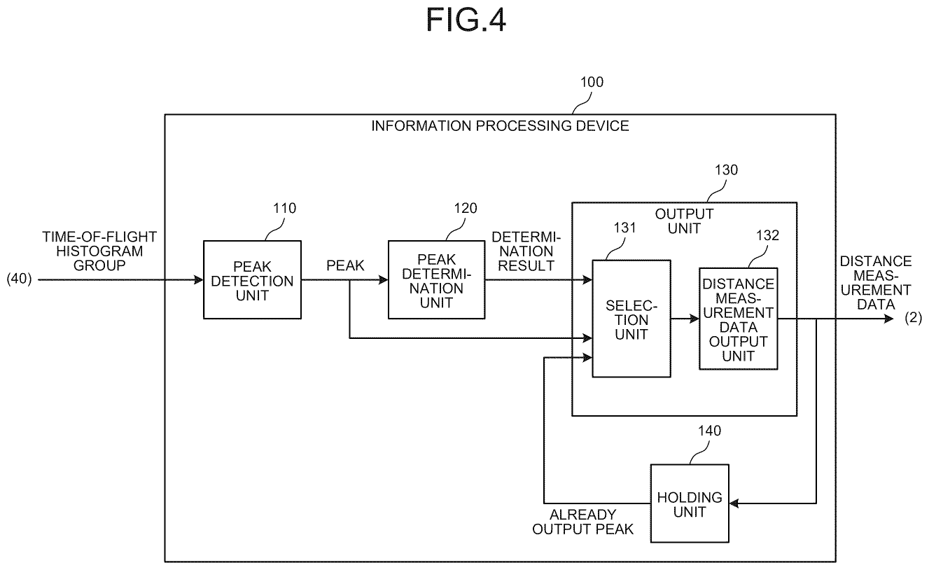

FIG. 4 is a diagram illustrating a configuration example of the information processing device according to a first embodiment of the present disclosure. The drawing is a block diagram illustrating a configuration example of the information processing device 100. The information processing device 100 includes a peak detection unit 110, a peak determination unit 120, an output unit 130, and a holding unit 140.

The peak detection unit 110 detects a peak from the time-of-flight histogram of the time-of-flight histogram group. This peak detection unit 110 detects a peak for each pixel region and outputs the peak to the peak determination unit 120.

The peak determination unit 120 detects a reflected light peak from the peak output from the peak detection unit 110. This reflected light peak is a peak based on reflected light from an object. The peak determination unit 120 outputs the detected reflected light peak to the output unit 130. The peak determination unit 120 can detect the reflected light peak on the basis of a maximum detection frequency at the peak and a width of the peak. Specifically, the peak determination unit 120 determines whether or not the peak is a reflected light peak on the basis of a threshold of the maximum detection frequency of the peak and a threshold of the width of the peak. The peak determination unit 120 outputs the reflected light peak as a determination result to the output unit 130.

The output unit 130 outputs the peak as distance measurement data. This output unit 130 selects a peak on the basis of the reflected light peak from the peak determination unit 120 and an already output peak which is a previously output peak, and outputs the selected peak as distance measurement data. Furthermore, the output unit 130 selects a peak for each pixel region and outputs the peak as distance measurement data. The output unit 130 includes a selection unit 131 and a distance measurement data output unit 132.

The selection unit 131 performs selection on the basis of the reflected light peak from the peak determination unit 120 and the already output peak. In this selection, for example, the peak determined as the reflected light peak is selected in descending order of the detection frequency. In addition, the selection unit 131 preferentially selects a peak based on the already output peak. This peak based on the already output peak corresponds to, for example, a peak whose class substantially matches that of the already output peak. This is a peak belonging to the same time-of-flight data 310 as the already output peak. The selection unit 131 outputs a predetermined number, for example, three, of the selected peaks to the distance measurement data output unit 132.

The distance measurement data output unit 132 outputs the peak selected by the selection unit 131 as distance measurement data. In addition, the distance measurement data output unit 132 outputs the peak selected by the selection unit 131 to the holding unit 140.

The holding unit 140 holds an already output peak that is the peak output from the output unit 130. This holding unit 140 outputs the held already output peak to the output unit 130.

### [Configuration of Peak Detection Unit]

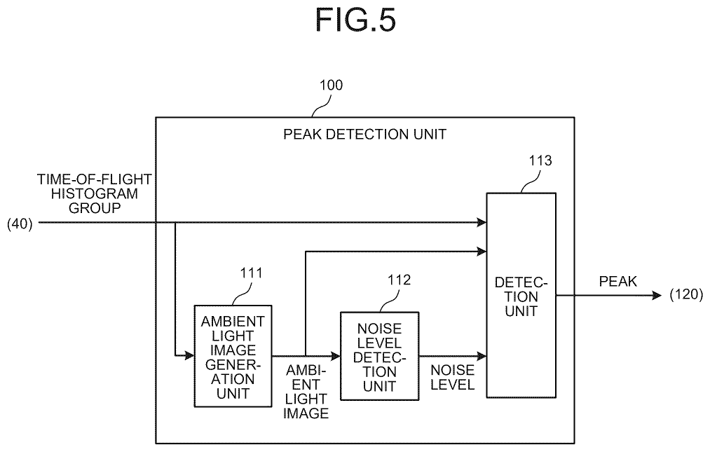

FIG. 5 is a diagram illustrating a configuration example of the peak detection unit according to the embodiments of the present disclosure. The drawing is a block diagram illustrating a configuration example of the peak detection unit 110. The peak detection unit 110 includes an ambient light image generation unit 111, a noise level detection unit 112, and a detection unit 113.

The ambient light image generation unit 111 generates an ambient light image. This ambient light image is an image based on an ambient light frequency that is a detection frequency of ambient light, and is an image based on ambient light for each pixel region. A component of the detection frequency of the ambient light in the time-of-flight histogram is an error of time-of-flight detection. Therefore, by detecting the detection frequency of the ambient light and subtracting the detection frequency from the time-of-flight histogram, the error of the time-of-flight detection can be reduced. The ambient light image generation unit 111 generates an ambient light image as the detection frequency of the ambient light. This ambient light image can be generated by taking an average value of detection frequencies of classes for the respective pixel regions. The generated ambient light image is output to the noise level detection unit 112 and the detection unit 113.

The noise level detection unit 112 detects a noise level of the time-of-flight histogram. This noise level detection unit 112 detects a noise level on the basis of the ambient light image and outputs the noise level to the detection unit 113. The noise level of the time-of-flight histogram depends on the ambient light. Therefore, a relationship between intensity of the ambient light and the noise level is measured in advance, and a measurement result is held in the noise level detection unit 112. The noise level detection unit 112 can detect the noise level for each pixel region from the ambient light image on the basis of this measurement result.

The detection unit 113 detects a peak from the time-of-flight histogram on the basis of the detection frequency of the ambient light. The detection unit 113 in the drawing detects a peak on the basis of the ambient light image and the noise level. Specifically, the detection unit 113 detects a region exceeding the ambient light frequency and the noise level in an upwardly protruding region of the time-of-flight histogram as a peak. The detection unit 113 outputs the detected peak to the peak determination unit 120.

### [Selection of Peak]

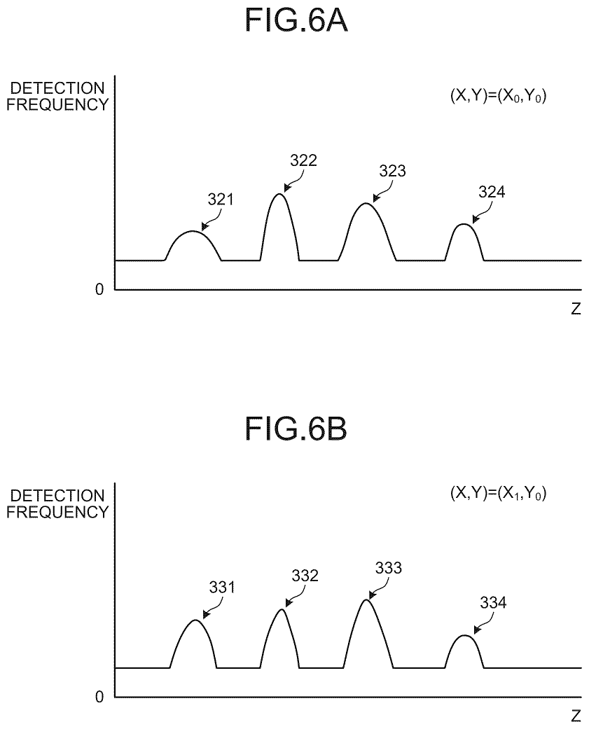

FIGS. 6A and 6B are diagrams each illustrating an example of selection of a peak according to the embodiments of the present disclosure. The drawings are diagrams each illustrating a time-of-flight histogram. FIG. 6A illustrates a time-of-flight histogram of a pixel region with coordinates (X, Y) of (X₀, Y₀). In the time-of-flight histogram in the drawing, a peak 322, a peak 323, a peak 324, and a peak 321 are described in descending order of a detection frequency. Among them, the peak 322, the peak 323, and the peak 324 are peaks output from the output unit 130, and correspond to already output peaks.

FIG. 6B illustrates a time-of-flight histogram of a pixel region with coordinates (X, Y) of (X₁, Y₀). This is a pixel region adjacent to the above-described pixel region. In the time-of-flight histogram in the drawing, a peak 333, a peak 332, a peak 331, and a peak 334 are described in descending order of a detection frequency. In this case, the peak having the high detection frequency is selected, and the peak 334, which is a peak of the same class as the already output peak in the pixel region of (X₀, Y₀), is preferentially selected. Specifically, the selection unit 131 selects the peak 333, the peak 332, and the peak 334. In this manner, the peak 334 is selected instead of the peak 331.

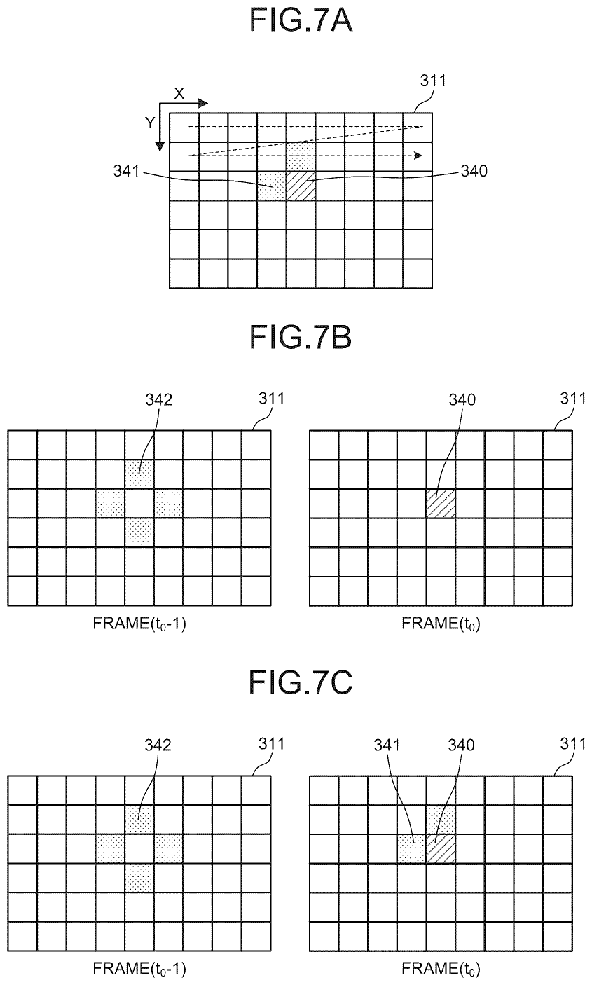

FIGS. 7A to 7C are diagrams each illustrating an example of selection of a peak according to the embodiments of the present disclosure. The drawings are diagrams each illustrating an example of a pixel region that is a target of an already output peak. In the drawings, a rectangle represents the pixel region 311. As illustrated in the drawings, the pixel regions 311 are two-dimensionally arranged in the X and Y directions. Furthermore, a hatched pixel region in the pixel regions represents a focused pixel region 340 that is a target of peak selection by the selection unit 131. Furthermore, a pixel region to which dot hatching is applied represents an already output pixel region 341 corresponding to the already output peak.

FIG. 7A illustrates an example of a case where pixel regions adjacent to left and upper sides of the focused pixel region 340 are set as the already output pixel regions 341. Note that a dotted arrow in the drawing indicates scanning order of the pixel regions.

FIG. 7B illustrates an example of a case where, in consecutive frames (t₀-1) and (t₀), pixel regions in the frame (t₀-1) immediately before the frame (t₀) of the focused pixel region 340 are set as already output pixel regions 342. The already output pixel regions 342 in the drawing are pixel regions in the previous frame adjacent to the focused pixel region 340.

FIG. 7C illustrates an example of a case where the already output pixel regions 341 and the already output pixel regions 342 are used in combination.

The selection unit 131 in FIG. 4 reads the already output peak such as the already output pixel region 341 from the holding unit 140 and applies the read peak to selection of the peak.

In this manner, by selecting and outputting the peak of the focused pixel region 340 on the basis of the already output peak of the pixel region adjacent to the focused pixel region 340, data having a spread in the X direction and the Y direction can be output to the processor 3 in a subsequent stage. As a result, it is possible to prevent missing of information when the processor 3 performs calculation with reference to information in the X direction and the Y direction. The calculation referring to the information in the X direction and the Y direction corresponds to, for example, noise reduction processing and flare removal processing. Here, the flare is a peak based on reflected light scattered by a target portion.

### [Information Processing Method]

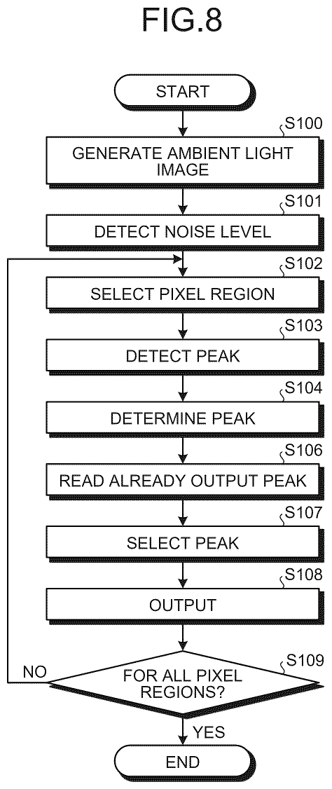

FIG. 8 is a diagram illustrating an example of a processing procedure of information processing according to the first embodiment of the present disclosure. The drawing is a flowchart illustrating an example of an information processing method in the information processing device 100. First, the ambient light image generation unit 111 generates an ambient light image from a time-of-flight histogram group (step S100). Next, the noise level detection unit 112 detects a noise level from the ambient light image (step S101). Next, the information processing device 100 selects a pixel region of the time-of-flight histogram group (step S102). Next, the peak detection unit 110 detects a peak of the time-of-flight histogram in the selected pixel region (step S103). Next, the peak determination unit 120 determines a peak (step S104). Next, the selection unit 131 reads an already output peak from the holding unit 140 (step S106). Next, the selection unit 131 selects a peak on the basis of a determination result and the already output peak (step S107). Next, the distance measurement data output unit 132 outputs the peak as distance measurement data (step S108).

Next, the information processing device 100 determines whether the output of the distance measurement data has been completed for all the pixel regions (step S109). In a case where the output of the distance measurement data has not been completed for all the pixel regions (step S109, No), the information processing device 100 proceeds to step S102 and selects another pixel region. On the other hand, in a case where the output of the distance measurement data has been completed for all the pixel regions (step S109, Yes), the information processing device 100 ends the processing.

Note that step S103 is an example of a peak detection procedure. Step S104 is an example of a determination procedure. Step S107 is an example of a selection procedure. Step S108 is an example of an output procedure.

As described above, the information processing device 100 according to the first embodiment of the present disclosure outputs the peak selected on the basis of the determination result of the reflected light peak and the already output peak as the distance measurement data. As a result, it is possible to transmit data that can be used for processing of the processor 3 in the subsequent stage while reducing an amount of output data.

### 2. Second Embodiment

The information processing device 100 according to the first embodiment described above acquires the already output peak by using the pixel region adjacent to the focused pixel region 340 as the already output pixel region 341 or the like. On the other hand, the information processing device 100 according to a second embodiment of the present disclosure is different from the above-described first embodiment in that an already output pixel region is further selected.

### [Configuration of Information Processing Device]

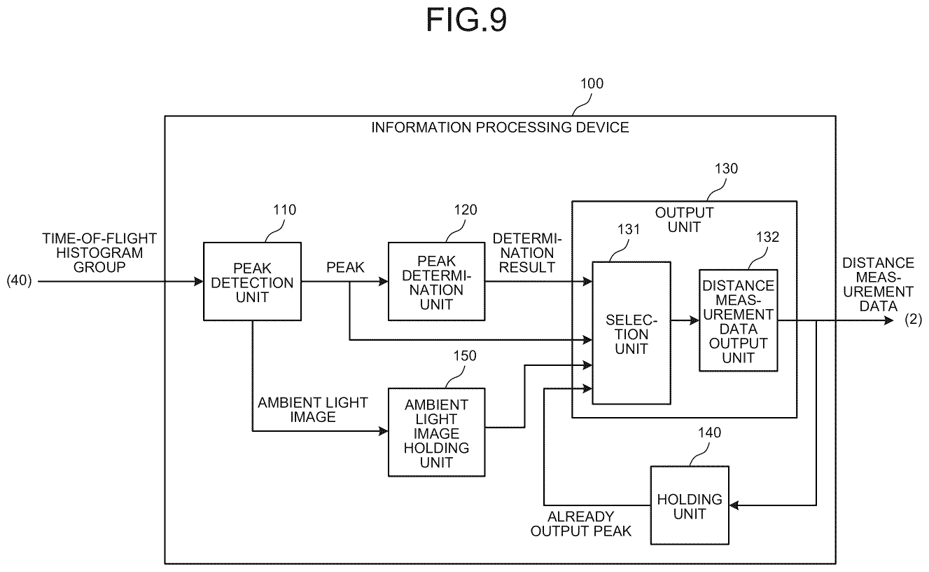

FIG. 9 is a diagram illustrating a configuration example of the information processing device according to the first embodiment of the present disclosure. Similarly to FIG. 4, the drawing is a block diagram illustrating a configuration example of the information processing device 100. The information processing device 100 in the drawing is different from the information processing device 100 in FIG. 4 in that an ambient light image holding unit 150 is further included.

The ambient light image holding unit 150 in the drawing holds an ambient light image generated by the ambient light image generation unit 111 of the peak detection unit 110. This ambient light image holding unit 150 outputs the held ambient light image to the selection unit 131.

The selection unit 131 in the drawing selects a peak on the basis of a determination result of the peak determination unit 120, an already output peak from the holding unit 140, and the ambient light image. Specifically, the selection unit 131 in the drawing selects an already output pixel region for acquiring an already output peak on the basis of the ambient light image, and further selects a peak on the basis of the already output peak of the selected already output pixel region.

### [Ambient Light Image]

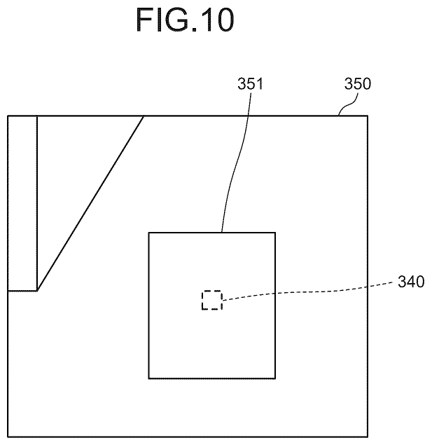

FIG. 10 is a diagram illustrating an example of an ambient light image according to the second embodiment of the present disclosure. The drawing is a diagram illustrating an example of an ambient light image 350 generated by the ambient light image generation unit 111 and held in the ambient light image holding unit 150. A region 351 having the same luminance is described in the ambient light image 350 in the drawing. Furthermore, a dotted rectangle in the drawing represents the focused pixel region 340. In a case where the focused pixel region 340 is included in the region 351 having the same luminance, an adjacent pixel region in the region 351 is used as the already output pixel region.

Such a region 351 corresponds to a region of the reflected light reflected by the same object. Therefore, by selecting a peak on the basis of the already output peak of the pixel region in the region, it is possible to prevent missing of data in the Z-axis direction due to the same object.

### [Information Processing Method]

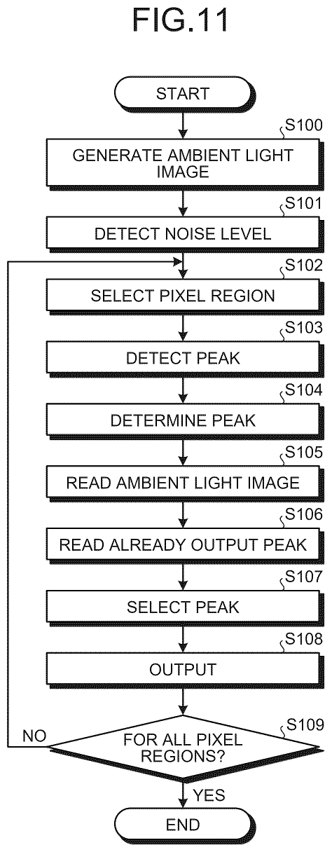

FIG. 11 is a diagram illustrating an example of a processing procedure of information processing according to the second embodiment of the present disclosure. Similarly to FIG. 8, the drawing is a flowchart illustrating an example of an information processing method in the information processing device 100. In the processing procedure of the drawing, processing of step S105 is performed between steps S104 and S106. In step S105, the selection unit 131 reads an ambient light image from the ambient light image holding unit 150 (step S105). Thereafter, in step S107, the selection unit 131 selects a peak on the basis of a determination result, the already output peak, and the ambient light image (step S107). Since the processing procedure other than this is similar to the processing procedure of FIG. 8, description thereof is omitted.

Other configurations of the information processing device 100 are similar to those of the information processing device 100 according to the first embodiment of the present disclosure, and thus, description thereof is omitted.

As described above, the information processing device 100 according to the second embodiment of the present disclosure selects a peak on the basis of the determination result, the already output peak, and the ambient light image. Since the already output pixel region is selected on the basis of the ambient light image, the already output peak can be narrowed down.

### 3. Third Embodiment

The information processing device 100 according to the first embodiment described above acquires the already output peak by using the pixel region adjacent to the focused pixel region 340 as the already output pixel region 341 or the like. On the other hand, the information processing device 100 according to a third embodiment of the present disclosure is different from the above-described first embodiment in that an already output peak is acquired by detecting a region where peaks are continuous in a linear shape.

### [Configuration of Information Processing Device]

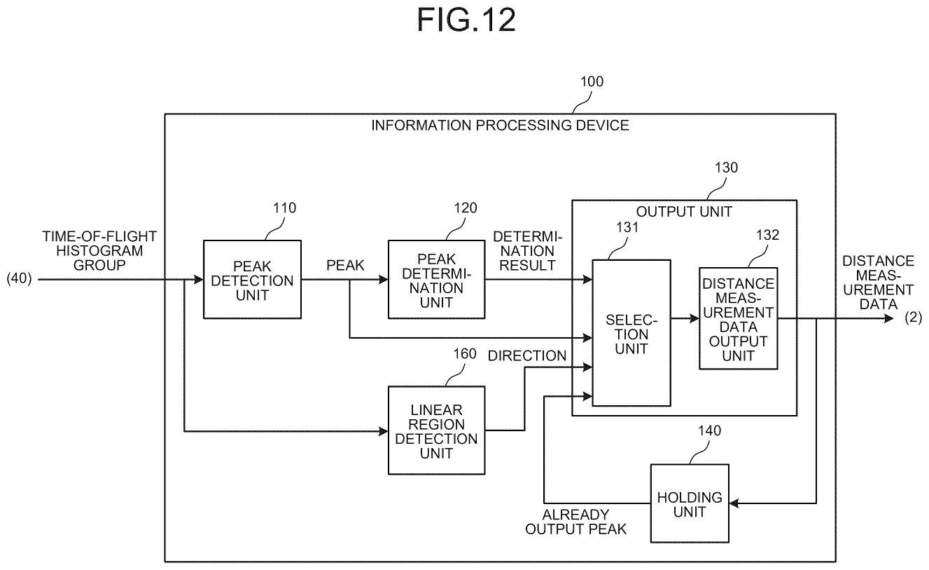

FIG. 12 is a diagram illustrating a configuration example of an information processing device according to the third embodiment of the present disclosure. Similarly to FIG. 4, the drawing is a block diagram illustrating a configuration example of the information processing device 100. The information processing device 100 in the drawing is different from the information processing device 100 in FIG. 4 in that a linear region detection unit 160 is further included.

The linear region detection unit 160 detects a linear region that is a region in which peaks of maximum detection frequencies are linearly continuous. For example, the linear region detection unit 160 outputs an extending direction of the detected linear region to the selection unit 131.

The selection unit 131 in the drawing selects a peak on the basis of a determination result of the peak determination unit 120, an already output peak from the holding unit 140, and the linear region. Specifically, the selection unit 131 in the drawing selects an already output pixel region for acquiring an already output peak on the basis of the extending direction of the linear region, and further selects a peak on the basis of the already output peak of the selected already output pixel region.

### [Configuration of Information Processing Device]

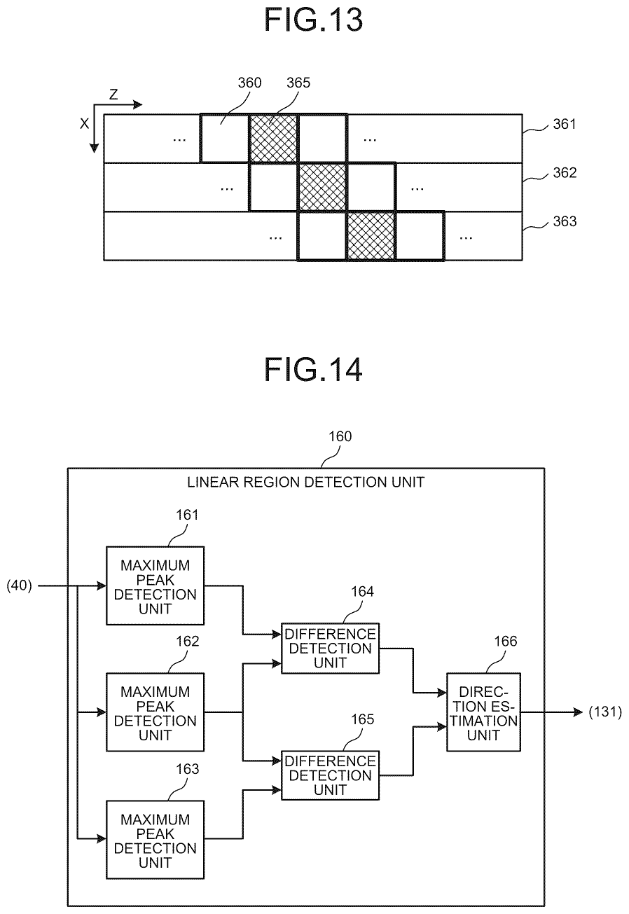

FIG. 13 is a diagram illustrating an example of a linear region according to the third embodiment of the present disclosure. This drawing illustrates regions of classes in the X-axis and Z-axis directions. This drawing represents adjacent regions 360 in adjacent rows 361, 362, and 363 in a specific X coordinate. A hatched region in the rows 361, 362, and 363 in the drawing represents a region 365 including a peak of a maximum detection frequency. As illustrated in the drawing, there is a high possibility that a region where the regions 365 are continuous is a region where the same structure exists. Therefore, the already output pixel region is detected on the basis of the extending direction of the linear region which is the region, and the already output peak is acquired. By selecting a peak on the basis of the already output peak, it is possible to prevent missing of a peak corresponding to the same structure.

### [Configuration of Linear Region Detection Unit]

FIG. 14 is a diagram illustrating a configuration example of the linear region detection unit according to the third embodiment of the present disclosure. The linear region detection unit 160 in the drawing includes maximum peak detection units 161, 162, and 163, difference detection units 164 and 165, and a direction estimation unit 166.

The maximum peak detection units 161 to 163 detect the region 365 including the peak of the maximum detection frequency illustrated in FIG. 13 for each row of the time-of-flight histogram group. The maximum peak detection units 161, 162, and 163 detect the region 365 of FIG. 13 for the regions in the adjacent rows.

The difference detection units 164 and 165 detect a difference in the Z-axis direction between the regions 365 detected by the maximum peak detection units 161, 162, and 163. The difference detection unit 164 detects a difference between the regions 365 detected by the maximum peak detection units 161 and 162, and outputs a detection result to the direction estimation unit 166. The difference detection unit 165 detects a difference between the regions 365 detected by the maximum peak detection units 162 and 163, and outputs a detection result to the direction estimation unit 166.

The direction estimation unit 166 estimates a direction of the linear region on the basis of the differences detected by the difference detection units 164 and 165. For example, when the difference in the X-axis direction is a value of 2 and the difference in the Z-axis direction is a value of 2, the extending direction of the linear region can be estimated as an upward direction in FIG. 13. The direction estimation unit 166 outputs the estimated direction to the selection unit 131.

In this case, the selection unit 131 selects an already output pixel region in the extending direction of the linear region, and further selects a peak using the already output peak of the already output pixel region.

### [Information Processing Method]

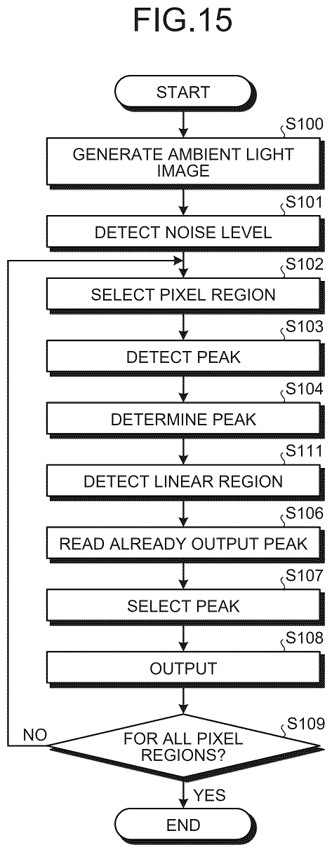

FIG. 15 is a diagram illustrating an example of a processing procedure of information processing according to the third embodiment of the present disclosure. Similarly to FIG. 8, the drawing is a flowchart illustrating an example of an information processing method in the information processing device 100. In the processing procedure of the drawing, processing of step S111 is performed between steps S104 and S106. In step S111, the linear region detection unit 160 detects a linear region (step S111). Thereafter, in step S107, the selection unit 131 selects a peak on the basis of a determination result, the already output peak, and the linear region (step S107). Since the processing procedure other than this is similar to the processing procedure of FIG. 8, description thereof is omitted.

Other configurations of the information processing device 100 are similar to those of the information processing device 100 according to the first embodiment of the present disclosure, and thus, description thereof is omitted.

As described above, the information processing device 100 according to the third embodiment of the present disclosure selects a peak on the basis of the determination result, the already output peak, and the detected linear region. Since the already output pixel region is selected on the basis of the linear region, the already output peak can be narrowed down.

Note that the configuration of the second embodiment of the present disclosure can be applied to other embodiments. Specifically, the configurations of the ambient light image holding unit 150 and the selection unit 131 in FIG. 9 can be applied to the third embodiment of the present disclosure.

Note that the effects described in the present specification are merely examples and are not limited, and other effects may be provided.

Note that the present technology can also have the following configurations.

(1) An information processing device comprising:
a peak detection unit that detects a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency;
a peak determination unit that determines whether or not the peak includes a peak corresponding to the reflected light; and
an output unit that outputs, as distance measurement data, the peak selected on a basis of a determination result of the peak determination unit and an already output peak previously output.
   (2) The information processing device according to the above (1), wherein
the peak detection unit sequentially detects the peak for each of pixel regions in a time-of-flight histogram group that is the time-of-flight histograms for the pixel regions of the two-dimensional pixel array unit, and
the output unit sequentially outputs the distance measurement data for each of the pixel regions.
   (3) The information processing device according to the above (2), wherein the output unit sets, as the already output peak, the peak output in the other pixel region in a same frame in the time-of-flight histogram group generated in a time-series frame period.
   (4) The information processing device according to the above (3), wherein the output unit sets, as the already output peak, the peak in a region where the peaks of maximum detection frequencies of a plurality of the classes are linearly continuous.
   (5) The information processing device according to the above (2), wherein the output unit sets, as the already output peak, the peak output in the pixel region in a previous frame in the time-of-flight histogram group generated in a time-series frame period.
   (6) The information processing device according to any one of the above (2) to (5), further comprising
an ambient light detection unit that detects an ambient light frequency that is a detection frequency of ambient light on a basis of the time-of-flight histogram, wherein
the output unit further selects the already output peak on a basis of the ambient light frequency.
   (7) The information processing device according to the above (6), wherein the output unit selects the already output peak in the pixel region having the substantially equal ambient light frequency.
   (8) An information processing method comprising:
detecting a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency;
determining whether or not the peak includes a peak corresponding to the reflected light;
selecting the peak on a basis of a result of the determination and an already output peak previously output; and
outputting the selected peak as distance measurement data.
   (9) A program comprising:
a peak detection procedure of detecting a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency;
a determination procedure of determining whether or not the peak includes a peak corresponding to the reflected light;
a selection procedure of selecting the peak on a basis of a result of the determination and an already output peak previously output; and
an output procedure of outputting the selected peak as distance measurement data.

### REFERENCE SIGNS LIST

1 DISTANCE MEASUREMENT DEVICE
2 DISTANCE MEASUREMENT SENSOR
3 PROCESSOR
40 HISTOGRAM DATA GENERATION UNIT
100 INFORMATION PROCESSING DEVICE
110 PEAK DETECTION UNIT
111 AMBIENT LIGHT IMAGE GENERATION UNIT
120 PEAK DETERMINATION UNIT
130 OUTPUT UNIT
131 SELECTION UNIT
140 HOLDING UNIT
150 AMBIENT LIGHT IMAGE HOLDING UNIT
160 LINEAR REGION DETECTION UNIT

1. An information processing device comprising:
a peak detection unit that detects a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency;
a peak determination unit that determines whether or not the peak includes a peak corresponding to the reflected light; and
an output unit that outputs, as distance measurement data, the peak selected on a basis of a determination result of the peak determination unit and an already output peak previously output.

2. The information processing device according to claim 1, wherein
the peak detection unit sequentially detects the peak for each of pixel regions in a time-of-flight histogram group that is the time-of-flight histograms for the pixel regions of the two-dimensional pixel array unit, and
the output unit sequentially outputs the distance measurement data for each of the pixel regions.

3. The information processing device according to claim 2, wherein the output unit sets, as the already output peak, the peak output in the other pixel region in a same frame in the time-of-flight histogram group generated in a time-series frame period.

4. The information processing device according to claim 3, wherein the output unit sets, as the already output peak, the peak in a region where the peaks of maximum detection frequencies of a plurality of the classes are linearly continuous.

5. The information processing device according to claim 2, wherein the output unit sets, as the already output peak, the peak output in the pixel region in a previous frame in the time-of-flight histogram group generated in a time-series frame period.

6. The information processing device according to claim 2, further comprising
an ambient light detection unit that detects an ambient light frequency that is a detection frequency of ambient light on a basis of the time-of-flight histogram, wherein
the output unit further selects the already output peak on a basis of the ambient light frequency.

7. The information processing device according to claim 6, wherein the output unit selects the already output peak in the pixel region having the substantially equal ambient light frequency.

8. An information processing method comprising:
detecting a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency;
determining whether or not the peak includes a peak corresponding to the reflected light;
selecting the peak on a basis of a result of the determination and an already output peak previously output; and
outputting the selected peak as distance measurement data.

9. A program comprising:
a peak detection procedure of detecting a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency;
a determination procedure of determining whether or not the peak includes a peak corresponding to the reflected light;
a selection procedure of selecting the peak on a basis of a result of the determination and an already output peak previously output; and
an output procedure of outputting the selected peak as distance measurement data.
